(19) United States
(12) Patent Application Publication
(10) Pub. No.: US 2006/0046025 A1
(43) Pub. Date: Mar. 2, 2006

(54) Laminated sealing material and method for its production

(75) Inventors: Joerg Latte, Sengen (CH); Urs Hochstrasser, Graenichen (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Klinger AG, Zug (CH)

(21) Appl. No.: 11/208,026

(22) Filed: Aug. 18, 2005

(30) Foreign Application Priority Data
Aug. 25, 2004 (DE) 102004041043.7

(51) Int. Cl. B32B 3/10; B32B 27/00; B32B 29/00

(52) U.S. Cl. 428/138; 428/421; 428/537.5; 156/89.25

(57) ABSTRACT

The invention relates to a laminated sealing material comprising at least two layers which are bonded to one another, at least a first layer of which is a graphite foil, which is bonded to a second layer of graphite foil, fluoropolymer or paper, the first and second layers being adhesively bonded to one another by means of a layer of fluoropolymer applied over a preferably aqueous dispersion.

### FIELD OF THE INVENTION

The invention relates to a laminated sealing material and a method for its production. Such sealing material may be used for the production of sealing rings, gaskets, bushings, stuffing boxes or the like.

### BACKGROUND OF THE INVENTION

Sealing materials in the form of graphite laminates have long been known. For their production, foils of expanded graphite of various thickness and density are laminated into sheets of greater thickness. The reason for this is that these foils can only be cost-effectively produced with a thickness of 1.0 mm to 1.5 mm and, in exceptional cases up to 3.0 mm. To achieve greater thicknesses and/or to stabilize the sensitive graphite foils, the following methods are used application-specifically:
1. bonding together at least two foils by means of an adhesive,
2. impregnating individual foils and laminates with polymers,
3. laminating foils onto a metal mesh, whereby mechanical interlocking with the metal mesh is achieved without the use of an adhesive,
4. adhesive bonding of two foils or laminates on both sides of a smooth metal sheet,
5. pressing of expanded metal into foils placed on both sides, an adhesive being used for the bonding.

The use of adhesives and impregnating agents does, however, have the effect that the graphite, which in its pure form is stable even at relatively high temperature, is destabilized at elevated temperature by softening and subsequent pyrolysis of the organic adhesives and impregnating agents. When it is specifically used as a preliminary material for flat gaskets, this has extremely adverse effects, one reason being because, depending on the amount of adhesive and/or impregnating agent that is used, the compressive load-bearing capacity of the gasket falls and, when pyrolysis occurs, there is a reduction in the tightness of the seal.

In the case of foils mechanically laminated onto a metal perforated or tang sheet with which the disadvantages mentioned above cannot occur, the gastightness is a problem on account of leakage channels along the boundary surfaces with respect to the metal sheet.

Graphite foils are commercially offered at present in the specific densities of 0.7 g/cm³, 1.0 g/cm³ and 1.4 g/cm³. It is not technically possible at present to produce cost-effectively a higher density than 1.4 g/cm³. This has the result that all previously offered graphite-based seals have excessive leakage, and consequently do not satisfy the conditions for a high-grade seal as required by German regulations for the control of air pollution (VDI regulation 2440 on clean air, VDI=Association of German Engineers).

In order nevertheless to be able to produce a high-grade seal, it is known to introduce barriers into the graphite laminate by:
1. impregnating, with the disadvantages already mentioned;
2. by expanded metal reinforcement, the grid mesh of the expanded metal reducing the nonmetallic cross section of the seal while at the same time building up pressure lines along the expanded grid and resultant compaction of the graphite. Nevertheless, it is still necessary to use adequate adhesive, which acts like an impregnation, so that the above disadvantages also occur here;
3. by applying flanges to the inner edges of seals, which is complex and expensive.

It is also known per se, for example in the case of pans, to coat substrates with polytetrafluoroethylene (PTFE), in order to prevent foreign particles from adhering to the substrate. This effect is also used in the case of gasket sheets and seals, which are coated on the outside with PTFE as a release agent, in order to prevent adhesive attachment to the flange and in this way keep maintenance costs low.

### SUMMARY OF THE INVENTION

An object of the invention is to provide a sealing material which is laminated from at least two layers, has at least one layer comprising a graphite foil and not requiring any conventional adhesive or impregnating agent to fasten it.

A further object of the invention is to provide a method for producing a sealing material which is laminated from at least two layers, has at least one layer comprising a graphite foil and not requiring any conventional adhesive or impregnating agent to fasten it.

The invention accordingly relates to a laminated sealing material comprising at least two layers which are bonded to one another, at least a first layer of which is a graphite foil, which is bonded to a second layer of graphite foil, fluoropolymer or paper, the first and second layers being adhesively bonded to one another by means of a layer of fluoropolymer applied over a preferably aqueous dispersion. It has surprisingly been found that, in connection with a graphite foil which is to be laminated together with a further graphite foil or a sheet or film of fluoropolymer or paper (so-called sealing paper), a dispersion of fluoropolymer works as an adhesive or bonding agent.

Further, the invention relates to a method for producing a laminated sealing material from at least two layers which are bonded to one another, at least a first layer of which is a graphite foil which is bonded to a second layer of a material of the group comprising graphite foil, fluoropolymer or paper, wherein a dispersion of fluoropolymer is applied to at least one of two layers to be bonded to one another and, once the dispersion has dried, they are pressed against one another and in this way adhesively bonded to one another.

If, irrespective of its density, graphite foil is coated with a dispersion of fluoropolymer, for example by spraying, knife coating, screen printing, rolling or dipping, it can—once the dispersion has dried—be undetachably joined together by pressure alone with a second graphite foil and or a sheet or film of fluoropolymer or paper (sealing paper), the involved side of which is treated in the same way, or else may be untreated. A simultaneous increase in the temperature while joining the layers together is helpful. In this way, graphite laminated sheets or graphite composite sheets of any desired thickness can be created.

Further objects, advantages and embodiments may be taken from the following description.

For further stabilization of such a graphite or graphite composite laminate, a sintering process that is typical for the fluoropolymer may follow, without pressure or with pressing pressure under customary sintering conditions. Sheet or film material of fluoropolymer may be used in sintered or unsintered form for producing the graphite or graphite composite laminate.

From the laminated sealing material, unsintered or sintered, shaped parts, for example seals but also bodies shaped in any way desired, can be punched out, sawn out, cut out or milled out.

However, it has surprisingly also been found that, when punching with suitable punching tools from foils, films or sheets correspondingly provided with the dispersion, parts of relatively great thickness can be laminated together in a firmly bonding manner in the punching tool. In this way it is possible for example to obtain seals of customary thickness, for example 1.5 mm or 2.0 mm, or if appropriate of a desired thickness, only from very thin graphite foils, without taking the approach of building up a sheet laminate followed by punching out or the like. This may be a low-cost approach, for example for producing valve rings or tap bushings. These functional parts of valves not only need sealing but also the lowest possible actuating force when operating the valve. In order to keep down the frictional force between these functional elements on the valve piston or the valve spindle, these parts are nowadays dipped in PTFE dispersions, although only a small surface impregnation is achieved and disappears after some time as a result of operation, whereby the actuating force to be exerted when operating the valve increases again the longer it is in service. The invention makes it possible to produce laminated valve rings with a friction-reducing layer of fluoropolymer such as PTFE in a simple manner, for which reason the reduction of the frictional force is then permanent.

Foils coated with the dispersion can be laminated onto expanded metal without the use of an adhesive, since the expanded metal has corresponding openings in which the foils are adhesively bonded together after the dispersion has dried by the fluoropolymer layer that is formed. Instead of expanded metal, a perforated metal sheet or a wire mesh which has sufficiently large interspaces to permit adhesive bonding in the region of the interspaces can also be used.—The laminates may also be reinforced by a perforated or tang metal sheet in that they are applied to both sides of the latter.

The laminated sealing material of the invention offers the advantage that the fluoropolymer used as adhesive, in particular PTFE, has a correspondingly high temperature resistance in comparison with customary adhesives or impregnating agents, so that the operating temperature range of this laminated sealing material or seals and shaped bodies produced from it is almost as high as in the case of graphite, for example approximately 370°.

Films and sheets of fluoropolymer which can be used here may be filled with fillers or unfilled or expanded. By laminating on graphite foils, particularly hard sheets with a high filler content can provide the seals produced from them with the necessary adaptability to flange roughnesses. In the case of graphite valve rings with thicker layers of fluoropolymer (filled or unfilled), this has an extremely positive effect, as already mentioned, on the necessary actuating force when operating the valve.

Fluoropolymers here also include derivatives and polymers that are created by copolymerisation of the respective base monomer with other fluorine-containing copolymers, and also mixtures of fluoropolymers. These so-called fluoropolymers include not only PTFE but also for example ETFE, FEP, PCTFE, ECTFE, PVDF, PVF, PFA, MFA, TFEHFPVDF (THV) but also AF, a polymer which is soluble in halogenated solvents as a copolymer of PDD and TFE.

### BRIEF DESCRIPTION OF THE DRAWINGS

The invention is explained below on the basis of exemplary embodiments as shown in the attached drawings.

FIG. 1 shows an explosion view of a layer structure of an embodiment of a laminated sealing material.

FIGS. 2 and 3 show the layer structure of further embodiments of a sealing ring of laminated sealing material in section.

### DETAILED DESCRIPTION OF PREFERRED EMBODIMENTS

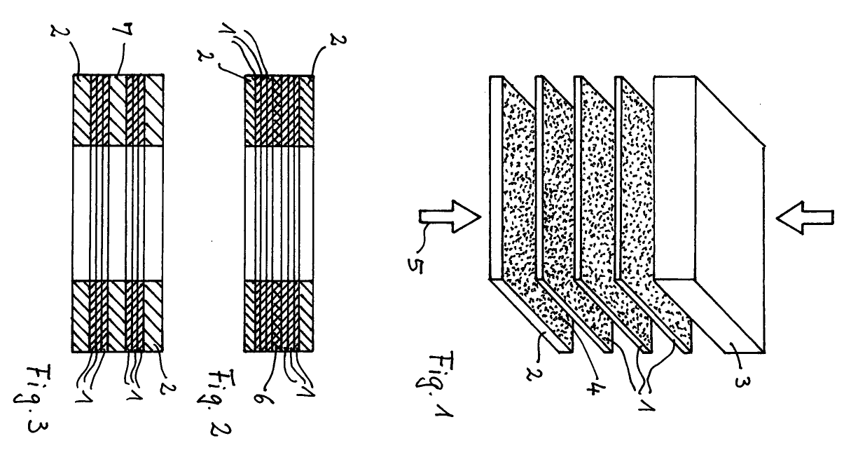

The layer structure of an embodiment of a laminated sealing material that is represented in FIG. 1 comprises a number of graphite foils 1 of pure graphite, an outer PTFE film 2 (or sealing paper) and a PTFE sheet 3, which is likewise on the outside. The dispersion 4 of fluoropolymer (PTFE) is applied to the foils or films 1,2 on one or both sides. Then the dispersion 4 is allowed to dry, so that the solid material of the dispersion 4 remains. The dispersion 4 of fluoropolymer may, if appropriate, also contain fillers that are typical for fluoropolymers, which likewise remain after the drying. To produce the laminated sealing material, these layers are brought into contact with one another in a press or a calender under pressing pressure (represented by the arrows 5) and in this way adhesively bonded to one another by means of the fluoropolymer applied as a dispersion 4 acting as an adhesive, to form a laminated sealing material.

The dispersion 4 is preferably an aqueous dispersion, but may also be a dispersion based on an organic liquid, for instance an alcohol or the like.

In the case of the sealing ring that is represented in FIG. 2, a centrally arranged expanded metal layer 6 is provided, on both sides of which there is respectively applied (one or) more than one graphite foil 1, which are adhesively bonded to one another by a PTFE dispersion, are in turn adhesively bonded to one another through the openings in the expanded metal and, furthermore, are respectively adhesively bonded on the outside to a PTFE film 2 via the PTFE dispersion.—Instead of an expanded metal layer, a perforated or tang metal sheet or also a wire mesh with sufficiently large interspaces may also be used.

In the case of the sealing ring that is represented in FIG. 3, a PTFE film 7 adhesively bonded to the neighbouring graphite foils 1 is provided instead of the expanded metal layer 6 from FIG. 2.—Here, the PTFE films 2 may also be omitted, so that on the outside there are graphite foils 1.

Laminated sealing material, for instance in the form of a sealing ring as represented in FIG. 2 or 3, a flat gasket, a stuffing box or the like, may be formed as such in a press from correspondingly shaped foil or film parts or be obtained from a sealing material previously laminated to form a sheet by punching, cutting or the like.

While the invention has been shown and described with reference to preferred embodiments, it should be apparent to one of ordinary skill in the art that many changes and modifications may be made without departing from the spirit and scope of the invention as defined in the claims.

What is claimed is:

1. A laminated sealing material comprising at least two layers which are bonded to one another, at least a first layer of which is a graphite foil, which is bonded to a second layer of a material of the group comprising graphite foil, fluoropolymer and paper, wherein the first and second layers are adhesively bonded to one another by means of a layer of fluoropolymer applied over a dispersion.

2. The material according to claim 1, wherein the dispersion is an aqueous dispersion.

3. The material according to claim 1, wherein the layer of fluoropolymer is one of the group comprising filled and unfilled material.

4. The material according to claim 1, wherein the layer of fluoropolymer is a film or a sheet.

5. The material according to claim 1, wherein it comprises at least one metal reinforcing layer.

6. The material according to claim 5, wherein the material reinforcing layer is an expanded metal layer.

7. The material according to claim 5, wherein the metal reinforcing layer is a metal tang sheet layer.

8. The material according to claim 1, wherein the metal reinforcing layer is one of the group comprising a perforated metal sheet and a wire mesh with large interspaces.

9. The material according to claim 1, wherein the dispersion is a polytetrafluoroethylene dispersion.

10. A seal comprising a laminated structure with at least two layers which are bonded to one another, at least a first layer of which is a graphite foil, which is bonded to a second layer of a material of the group comprising graphite foil, fluoropolymer and paper, wherein the first and second layers are adhesively bonded to one another by means of a layer of fluoropolymer applied over a dispersion.

11. A method for producing a laminated sealing material from at least two layers which are bonded to one another, at least a first layer of which is a graphite foil which is bonded to a second layer of a material of the group comprising graphite foil, fluoropolymer or paper, wherein a dispersion of fluoropolymer is applied to at least one of two layers to be bonded to one another and, once the dispersion has dried, they are pressed against one another and in this way adhesively bonded to one another.

12. The method according to claim 11, wherein an aqueous dispersion is used as the dispersion.

13. The method according to claim 11, wherein the layers are pressed onto one another.

14. The method according to claim 11, wherein the layers are pressed onto one another while exposed to elevated temperature.

15. The method according to claim 11, wherein the layers are pressed onto one another in a press.

16. The method according to claim 11, wherein the layers are pressed onto one another in a calender.

17. The method according to claim 11, wherein a sintering step follows the lamination step.
